(19) United States
(12) Patent Application Publication
(10) Pub. No.: US 2016/0219808 A1
(43) Pub. Date: Aug. 4, 2016

(54) Plant Watering Apparatus

(71) Applicants: Eduardo Cabral, Union City, CA (US); Dorie Cabral, Union City, CA (US)

(72) Inventors: Eduardo Cabral, Union City, CA (US); Dorie Cabral, Union City, CA (US)

(21) Appl. No.: 14/979,982

(22) Filed: Dec. 28, 2015

Related U.S. Application Data
(60) Provisional application No. 62/111,832, filed on Feb. 4, 2015.

(51) Int. Cl. A01G 29/00

(52) U.S. Cl. CPC A01G 29/00

(57) ABSTRACT

A plant watering apparatus for automatically watering plants. The plant watering apparatus includes a receptacle configured to support fluid therein. At least one tube is removably positioned within the receptacle for distributing fluid from the receptacle to a plant. The tube includes filler material therein configured to absorb the fluid from the receptacle so as to draw the fluid into the tube, wherein the absorption along with gravity cause the fluid to flow through the tube towards the plant. The tube includes a nozzle on an open end thereof that disperses the fluid flowing through the tube to a desired plant. The receptacle can be placed at a higher elevation than the plant so as to provide for gravitational flow of fluid through the tube and toward the plant.

### CROSS REFERENCE TO RELATED APPLICATION

This application claims the benefit of U.S. Provisional Application No. 62/111,832 filed on Feb. 4, 2015. The above identified patent application is herein incorporated by reference in its entirety to provide continuity of disclosure.

### FIELD OF THE INVENTION

The present invention relates to plant watering tools and accessories. More particularly, the present invention provides a plant watering apparatus having a tube with an absorbent filler material therein configured to control the flow rate of fluid therethrough so as to provide gradual and continuous watering of a plant.

### BACKGROUND OF THE INVENTION

Water is crucial to plant growth. Typically, plants require large quantities of water for growth due to transpiration. Transpiration is the loss of water from aerial parts, such as leaves, stems and flowers, through evaporation. Water is also utilized for photosynthesis for producing the carbohydrates necessary for plant growth, however, a large portion of water is lost by transpiration. Sunny and hot weather increases the rate of transpiration, which increases the demand for water. A foremost cause of wilting of plants is when they receive an inadequate supply of water.

However, although many people are concerned about under-watering their plants, another common cause for wilting plants is over-watering. Over-watering causes soil to become waterlogged, and the roots growing in such an environment cannot absorb the necessary oxygen needed to function normally. These roots begin to decay and eventually fail to supply the plant with the proper nutrients and water. Therefore, there exists a need for a plant watering apparatus that continuously provides water to a plant while preventing overwatering.

Devices have been disclosed in the prior art that relate to plant watering apparatuses. Some of these devices are limited to systems for dispersing water to one or more plants beneath the surface of the soil. Other devices are limited to watering systems having a delivery mechanism that includes a water supply tank and conduit. These devices, however, fail to provide a tube having filler material therein configured to control the flow of water therethrough.

The present invention overcomes these limitations by providing a plant watering apparatus that is configured to control the flow of water to a desired plant in order to prevent overwatering. The plant watering apparatus includes a receptacle configured to support fluid therein. The receptacle is fluidly connected to at least one tube having a nozzle on its end configured to disperse fluid therethrough. Preferably, the receptacle is disposed above a desired plant needing to be watered to allow for gravitational flow of the fluid. Filler material is positioned within the tube so as to allow fluid to slowly permeate therethrough from the receptacle to be dispersed through the nozzle.

It is therefore submitted that the present invention is substantially divergent in design elements from the prior art, and consequently it is clear that there is a need in the art for an improvement to plant watering apparatuses. In this regard, the instant invention substantially fulfills these needs.

### SUMMARY OF THE INVENTION

In view of the foregoing disadvantages inherent in the known types of plant watering apparatuses now present in the prior art, the present invention provides a plant watering apparatus wherein the same can be utilized for continuously watering a plant.

It is therefore an object of the invention to provide a new and improved plant watering apparatus that has all of the advantages of the prior art and none of the disadvantages.

Another object of the present invention is to provide a new and improved plant watering apparatus comprising a receptacle configured to support fluid therein.

Yet another object of the present invention is to provide a new and improved plant watering apparatus having at least one tube positioned within the receptacle and in fluid communication with the receptacle.

Still yet another object of the present invention is to provide a new and improved plant watering apparatus wherein the tube includes an absorbent filler material disposed therein configured to control the flow rate of fluid therethrough.

Yet a further object of the present invention is to provide a new and improved plant watering apparatus comprising a tube having a nozzle configured to disperse fluid to a desired plant.

Another object of the present invention is to provide a new and improved plant watering apparatus, wherein the tube comprises a valve for stopping the flow of fluid therethrough.

Still yet another object of the present invention is to provide a new and improved plant watering apparatus wherein the device may be readily fabricated from materials that permit relative economy and are commensurate with durability.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a side perspective view of the plant watering apparatus.

FIG. 2 shows a cross sectional view of the tube of the plant watering apparatus.

FIG. 3 shows a side perspective of an alternate embodiment of the plant watering apparatus.

### DETAILED DESCRIPTION OF THE INVENTION

Reference is made herein to the attached drawings. Like reference numerals are used throughout the drawings to depict like or similar elements of the plant watering apparatus. For the purposes of presenting a brief and clear description of the present invention, the preferred embodiment will be discussed as used for continuously watering plants while preventing overwatering. The figures are intended for representative purposes only and should not be considered to be limiting in any respect.

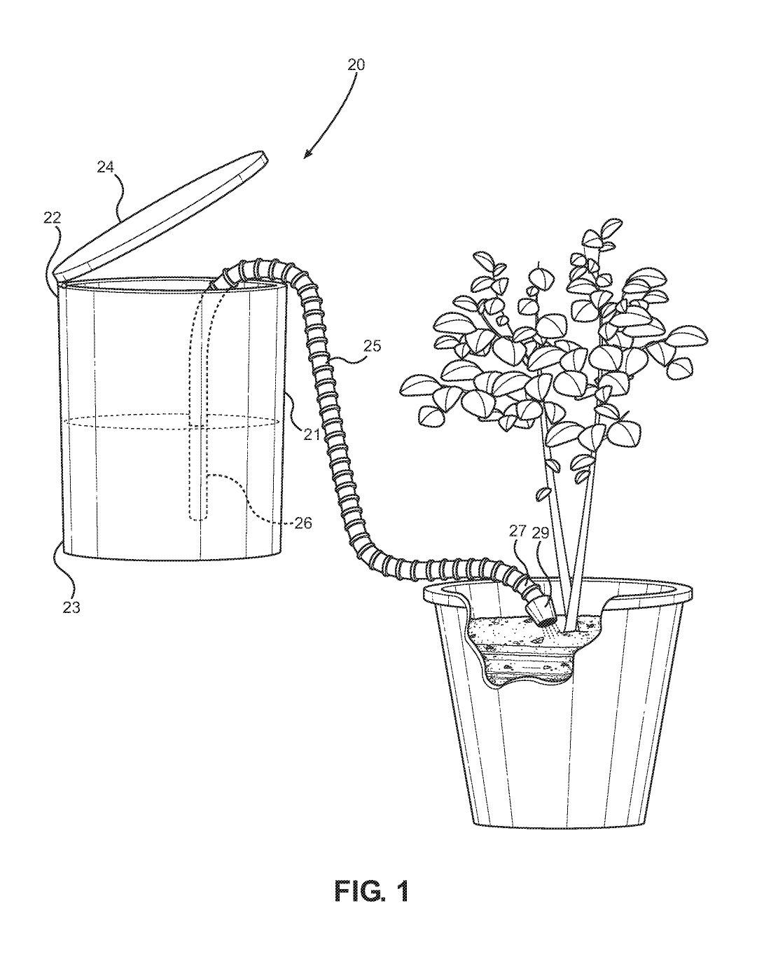

Referring now to FIG. 1, there is shown a side perspective view of the plant watering apparatus. The plant watering apparatus 20 comprises a receptacle 21 having a hollow interior volume that is configured to support water or other fluid therein. In the illustrated embodiment, the receptacle 21 is shown as having a cylindrical configuration, however, in alternate embodiments the receptacle 21 can have any of various configurations. The receptacle 21 includes an open upper end 22 and a closed lower end 23. The open upper end 22 includes a lid 24 that is pivotally attached thereto. In some embodiments, the lid 24 is removably attached to the upper end 22.

At least one tube 25 is removably positioned within the receptacle 21 so that the tube 25 is in fluid communication with the receptacle 21. The tube 25 includes a first end 26 and a second end 27 forming a hollow interior volume therethrough. In operation, the first end 26 of the tube 25 is positioned within the receptacle 21 and the tube 25 extends outward from the receptacle 21 and the second end 26 is positioned adjacent to a plant to be watered. The second end 26 of the tube 25 comprises a nozzle 29 thereon for dispersing water or other fluid to a plant. The nozzle 29 may include a valve thereon for closing the nozzle 29 so as to prevent any fluid from flowing therethrough. The tube 25 is preferably composed of a flexible material so that the tube 25 can be arranged in a desired configuration.

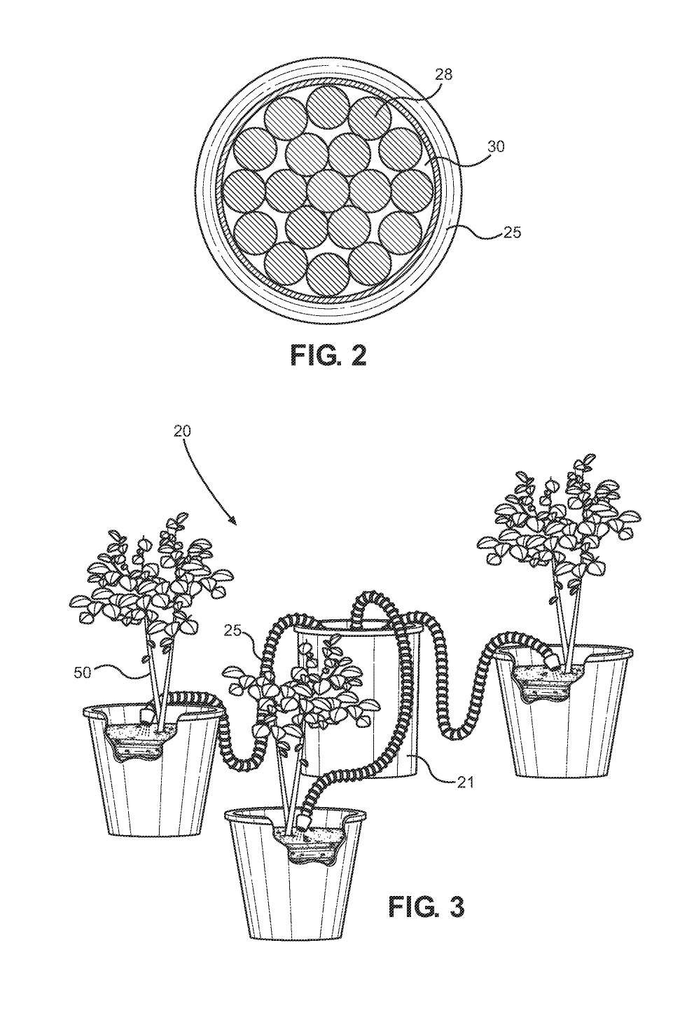

Referring now to FIG. 2, there is shown a cross sectional view of the tube of the plant watering apparatus. A filler material 28 is positioned within the tube 25. The filler material 28 is absorbent so as to draw fluid from the receptacle into the tube 25. The fluid is continuously absorbed by the filler material 28 so as to create a gradual flow of fluid into the tube 25. Once the fluid reaches a portion of the tube that extends downwardly from the receptacle 21 towards a plant, gravity further assists in producing a flow of fluid towards the plant. Thus, the filler material 28 helps to provide a slow, controlled flow of fluid towards the plant.

Various types of filler material 28 may be used so as to draw fluid into the tube 25 for distribution to the plant. In the illustrated embodiment, the filler material 28 comprises a bundle of fibers packed into the tube 25. The fibers are absorbent so as to allow fluid to flow therethrough and along the tube 25. The fluid is absorbed into the fibers and travels along the length of the fibers 28 from one end of the tube to the other. The fibers help to control the flow of fluid through the tube. In alternate embodiments, various other types of filler material 28 may be used, such as absorbent granules, among others.

Referring now to FIG. 3, there is shown a side perspective view of an alternate embodiment of the plant watering apparatus. In the illustrated embodiment, the plant watering apparatus 20 comprises a plurality of tubes 25 so that the apparatus 20 can be used to simultaneously water multiple plants.

In operation, the receptacle 21 can be filled with a fluid, such as water. The first end of each tube 25 is positioned within the receptacle 21 so that the tube 25 is in fluid communication therewith. The filler material inside of each tube causes the fluid to be drawn into the tube as the filler material slowly absorbs the fluid. As the filler material continues to absorb the liquid, the liquid moves upward along the tube. Once the tube turns downward towards the plant, gravity further helps to direct the flow of fluid towards the plants.

The nozzle 29 of each tube 25 can be positioned adjacent to a plant to be watered so that water is dispersed from the nozzle 29 and onto the plant or soil in which the plant is positioned. The filler material inside of the tubes 25 helps to control the flowrate of fluid therethrough. In this way, fluid is dispersed gradually and continuously through the tubes 25 so as to provide water to the plant while preventing overwatering that would result from too high of a flowrate of water to the plant. The user can periodically fill the receptacle 21 with fluid as the fluid therein is depleted.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A plant watering apparatus, comprising:
a receptacle configured to support a fluid therein;
at least one tube in fluid communication with the receptacle;
filler material disposed within said at least one tube, said filler material adapted to control a flow rate of the fluid therethrough.

2) The plant watering apparatus of claim 1, wherein the receptacle comprises an open upper end, wherein a lid is pivotally affixed to the open upper end.

3) The plant watering apparatus of claim 1, wherein said at least one tube is removably positioned within the receptacle.

4) The plant watering apparatus of claim 1, wherein a nozzle is positioned on an open end of the tube so as to disperse fluid to a plant.

5) The plant watering apparatus of claim 4, wherein the nozzle comprises a valve adapted to selectively close or open the nozzle.

6) The plant watering apparatus of claim 1, wherein the filler material comprises a bundle of absorbent fibers.
